(19) United States
(12) Patent Application Publication
(10) Pub. No.: US 2008/0222336 A1
(43) Pub. Date: Sep. 11, 2008

(54) DATA PROCESSING SYSTEM

(76) Inventors: Yoshikazu KIYOSHIGE, Tokyo (JP); Shunichi Iwata, Tokyo (JP); Kesami Hagiwara, Tokyo (JP); Akihiko Tomita, Tokyo (JP)

Correspondence Address: MILES & STOCKBRIDGE PC, 1751 PINNACLE DRIVE, SUITE 500, MCLEAN, VA, 22102-3833, US

(21) Appl. No.: 12/014,069

(22) Filed: Jan. 14, 2008

(30) Foreign Application Priority Data
Mar. 7, 2007 (JP) 2007-056491

(51) Int. Cl. G06F 9/30; G06F 13/14; G06F 9/302

(52) U.S. Cl. 710/305; 712/215; 712/221; 712/E09.016; 712/E09.017

(57) ABSTRACT

To allow to use arithmetic circuits of sharable resources by priority with a simple procedure. In a data processing system including central processing units and a plurality of arithmetic circuits, wherein the central processing units are able to supply a command to one arithmetic circuit based on one fetched instruction and supply a command to other arithmetic circuit based on other fetched instruction, a memory circuit is provided which is used to store first information indicating which arithmetic circuit is executing a command, and second information indicating which central processing unit has reserved the arithmetic circuit for execution of the next command. When the arithmetic circuit is already executing a command, reservation of the arithmetic circuit for execution of the next command using the second information of the memory circuit, makes it possible, after the execution, to assign operation commands fast to the arithmetic circuits and cause them to execute the commands.

### CROSS-REFERENCE TO RELATED APPLICATION

The present application claims priority from Japanese patent application No. 2007-56491 filed on Mar. 7, 2007, the content of which is hereby incorporated by reference into this application.

### BACKGROUND OF THE INVENTION

The present invention relates to a data processing system comprising, as shared resources, a plurality of arithmetic circuits such as a floating-point processing circuit and a digital signal processing arithmetic circuit which receive operation commands to operate, and relates to a technology effectively applied to, for example, a single chip microcomputer of a multiprocessor core.

A technology of effectively using the operation resources of a multiprocessor system is described in Patent Document 1 (International Publication No. WO 2002/061591 Pamphlet). This technology adopts an interface circuit in a data processing system, the interface circuit allowing other data processing systems to be coupled, as a bus master, to an internal bus of the data processing system, and allows peripheral resources coupled with the internal bus of the data processing system to be directly used by other external data processing systems.

### SUMMARY OF THE INVENTION

The inventors investigated that one processor core of a multiprocessor system distributes commands also to the arithmetic circuits of the other processor cores of the multiprocessor system to operate the arithmetic circuits of its own and other processor cores in parallel. According to this investigation, as can be analogized from Patent Document 1, one processor core can share the operation resources of other processor core, but must avoid any conflict of operation resources between both processor cores. However, it was found out by the inventors that only exclusive arbitration of use of operation resources is not sufficient to promote efficient use of sharable operation resources. If the shared operation resources are not allowed to be used by priority with a simple procedure, it is not possible that the arithmetic circuits of its own and other processor cores can be easily operated in parallel by distributing operation commands to other arithmetic circuits.

It is an object of the present invention to provide a data processing system in which arithmetic circuits which are shared resources can be used by priority with a simple procedure.

It is another object of the present invention to provide a data processing system in which one central processing unit can cause a plurality of arithmetic circuits to easily operate in parallel by distributing operation commands to the arithmetic circuits which are shared resources.

The above and further objects and novel features of the present invention will be apparent from the description in this specification and the accompanying drawings.

The outline of a typical one of inventions disclosed in this application will be briefly described below.

In a data processing system comprising central processing units and a plurality of arithmetic circuits, wherein the central processing units are able to supply a command to one arithmetic circuit based on one fetched instruction and supply a command to other arithmetic circuit based on other fetched instruction, a memory circuit is provided which is used to store first information indicating which arithmetic circuit is executing a command, and second information indicating which central processing unit has reserved the arithmetic circuit for execution of the next command. When operation commands are distributed to the arithmetic circuits which are shared resources, it can be determined by referring to the first information of the memory circuit whether the arithmetic circuits are already executing commands, so that any conflict among the arithmetic circuits can be easily avoided. When the arithmetic circuits are already executing commands, reservation of the arithmetic circuits for execution of the next commands using the second information of the memory circuit, makes it possible, after the execution, to assign operation commands fast to the arithmetic circuits and cause them to execute the commands.

Typical ones among the inventions disclosed in this application will be briefly described below.

Namely, the arithmetic circuits which are shared resources can be used by priority with a simple procedure to perform data processing.

Further, one central processing unit can cause a plurality of arithmetic circuits to easily operate in parallel by distributing operation commands to the arithmetic circuits which are shared resources.

### BRIEF DESCRIPTION OF THE DRAWINGS

FIG. 1 is a block diagram showing a data processing system DPRCS1 according to an example of the present invention;

FIG. 2 is a flow chart illustrating an instruction execution sequence performed by a central processing unit in the data processing system DPRCS1;

FIG. 3 illustrates the timing of parallel arithmetic processing for a plurality of FPU instructions;

FIG. 4 is a block diagram illustrating another data processing system DPRCS2;

FIG. 5 is a flow chart illustrating an instruction execution sequence for executing a FPU comparison instruction in the data processing system DPRCS2;

FIG. 6 illustrates the timing of arithmetic processing performed when addition results obtained by floating-point adding instructions are compared by a comparison instruction in the data processing system DPRCS2;

FIG. 7 is a flow chart illustrating an instruction execution sequence of operation assurance processing in the data processing system DPRCS2;

FIG. 8 illustrates the timing of operational processing for FPU instructions which are objects of operational assurance processing in the data processing system DPRCS2;

FIG. 9 is a block diagram illustrating still another data processing system DPRCS3;

FIG. 10 is a block diagram illustrating yet another data processing system DPRCS4; and

FIG. 11 is a block diagram illustrating still yet another data processing system DPRCS5.

### DETAILED DESCRIPTION OF THE PREFERRED EMBODIMENTS

### 1. Outline of Embodiments

First, an outline of typical embodiments of the present invention disclosed in this application will be described. The reference numerals and symbols in the figures which are referred to with parentheses in the outline description of the typical embodiments just exemplify ones included in concepts of components to which the reference numerals and symbols are attached.

[1] A data processing system according to a typical embodiment of the present invention includes a plurality of central processing units (CPU0, CPU1), a plurality of arithmetic circuits (FPU0, FPU1) capable of executing a command supplied from the central processing units, and a memory circuit (BREG, RREG, BREG0, BREG1, BREG0, BREG1, IREG0, and IREG1). The central processing units are able to supply a command to one arithmetic circuit based on one fetched instruction and supply a command to other arithmetic circuit based on other fetched instruction. The memory circuit is used to store first information (BF0, BF1) indicating which arithmetic circuit is executing the command and second information (RF0 and RF1, or, RF0_A, RF1_A, RF0_B, and RF1_B) indicating which central processing unit has reserved the arithmetic circuit for execution of the next command. Thus, when commands are distributed to the arithmetic circuits which are shared resources, it can be determined by referring to the first information of the memory circuit whether the arithmetic circuit is already executing a command, so that any conflict among the arithmetic circuits can be easily avoided. When the arithmetic circuit is already executing a command, reservation of the arithmetic circuit for execution of the next command using the second information of the memory circuit makes it possible, after the execution, to assign operation commands fast to the arithmetic circuits and cause them to execute the commands.

In one concrete embodiment, the central processing unit causes one arithmetic circuit assigned thereto to execute a first command, and determines, when using other arithmetic circuit assigned to other central processing unit, whether or not the other arithmetic circuit is under command execution by referring to the first information. The central processing unit supplies a second command to the other arithmetic circuit when the other arithmetic circuit is not under command execution, and determines, when the other arithmetic circuit is under command execution, whether or not the other arithmetic circuit has been reserved for command execution by referring to the second information. The central processing unit reserves the other arithmetic circuit when the other arithmetic circuit has not been reserved, supplies the second command to the other arithmetic circuit when the command execution of the other arithmetic circuit has finished before the one arithmetic circuit finishes execution of the first command, and supplies the second command to the one arithmetic circuit when the other arithmetic circuit is still under command execution when the one arithmetic circuit has finished execution of the first command. According to the above procedure, when executing a plurality of operation instructions, the central processing units are able to issue a command to the arithmetic circuits efficiently according to reserved or non-reserved states of the arithmetic circuits to cause the arithmetic circuits to execute the operation instructions.

In another concrete embodiment, the arithmetic circuit is an accelerator such as a floating-point processing circuit or a digital signal processing arithmetic circuit. The loads of the central processing unit can be reduced and the efficiency of data processing can be increased.

In still another concrete embodiment, the arithmetic circuit operates the first information, when the arithmetic circuit has finished operations according to a supplied operation command, so as to indicate that the arithmetic circuit is not under command execution. The state of the arithmetic circuit can be reflected to the first information more immediately than in the case the central processing unit operates the first information.

In another concrete embodiment, the data processing system further includes a plurality of arithmetic buses (FPUB0, FPUB1) which are individually coupled with the respective arithmetic circuits, and are commonly coupled with the central processing units. Bus conflicts which arise when the central processing units transfer operation commands to the arithmetic circuits and obtain the results of operation of the arithmetic circuits can be reduced.

In still another concrete embodiment, the memory circuit is commonly coupled with the arithmetic bus. Bus conflicts which arise when the central processing units refer to the memory circuit and the arithmetic circuits operate the memory circuit can be reduced.

In still another concrete embodiment, the data processing system further includes a comparison circuit coupled with the arithmetic bus. One input of the comparison circuit is coupled with one arithmetic bus, and the other input of the comparison circuit is coupled with the other arithmetic bus. The operation results of the floating-point processing circuits can be input to the comparison circuit through the operation buses through the central processing units, and can be compared by the comparison circuit. Thus, in such a case of executing two operation instructions, comparing the results of the operations, and then executing instructions using the comparison result, the number of steps of executing the instructions can be reduced. Furthermore, it becomes possible that a command according to one operation instruction is supplied to the two arithmetic circuits to allow the arithmetic circuits to operate individually, and the results of the operations are compared with the comparison circuit, so that it is also becomes possible to assure higher reliability than usual for the results of operation by the arithmetic circuits. For example, by providing an interrupt controller (INTC) which receives the comparison result by the comparison circuit as one interrupt factor, when the comparison is anticoincidence, re-execution of an operation instruction, failure verification processing for the arithmetic circuits, and the like can be performed according to the interrupt processing program of the interrupt controller.

[2] A data processing system according to an embodiment in another aspect includes a plurality of central processing units (CPU0, CPU1), a plurality of arithmetic circuits (FPU0, FPU1) capable of executing a command supplied from the central processing units, and a memory circuit. The central processing unit can supply a command to one arithmetic circuit based on one fetched instruction and supply a command to other arithmetic circuit based on other fetched instruction. The memory circuit is used to store first information (BF0, BF1) indicating which arithmetic circuit is executing the command and second information (RF0_A, RF1_A) indicating whether the arithmetic circuit has been reserved for execution of the next command. Thus, when commands are distributed to the arithmetic circuits which are shared resources, it can be determined by referring to the first information of the memory circuit whether the arithmetic circuits is already executing a command, so that any conflict between the arithmetic circuits can be easily avoided. When the arithmetic circuit is already executing a command, the arithmetic circuit is reserved for execution of the next command using the second information of the memory circuit, and thereby after the execution, commands can be assigned fast to the arithmetic circuit for execution of the commands.

In one concrete embodiment, the central processing unit causes one arithmetic circuit assigned thereto to execute a first command, and determines whether or not the other arithmetic circuit is under command execution, when using the other arithmetic circuit assigned to the other central processing unit, by referring to the first information. The central processing unit supplies a second command to the other arithmetic circuit when the other arithmetic circuit is not under command execution, and determines whether or not the other arithmetic circuit has been reserved for command execution, when the other of the arithmetic circuits are under command execution, by referring to the second information. The central processing unit reserves the other arithmetic circuit when the other arithmetic circuit has not been reserved by any of the central processing units, supplies the second command to the other arithmetic circuit when the command execution of the other arithmetic circuit has finished before the one arithmetic circuit finishes execution of the first command, and supplies the second command to the one arithmetic circuit when the other arithmetic circuit is still under command execution when the one arithmetic circuit has finished execution of the first command. According to the above procedure, when executing a plurality of operation instructions, the central processing unit can issue commands to the arithmetic circuits efficiently according to reserved or non-reserved states of the arithmetic circuits to cause the arithmetic circuits to execute the operation instructions.

The central processing unit has an internal memory circuit for storing information indicating which arithmetic circuit has been reserved for operation. According to this configuration, when the central processing unit confirms the reservation of its own, the central processing unit does not need to refer an external memory circuit. When information capable of indicating which central processing unit has reserved the arithmetic circuit for execution of the next command is employed as the second information, the central processing unit needs to refer the second information for confirmation of operation reservation of its own.

[3] A data processing system according to an embodiment in another aspect includes a plurality of processor cores (PCORE0, PCORE1), a first register (BREG), and a second register (RREG). Each of the processor cores has an arithmetic circuit (FPU0, FPU1) which receives an operation command of its own and from other processor cores to operate. The first register is used to store information (BF0, BF1) indicating whether each of the arithmetic circuits is used, and can be accessed by the processor cores. The second register is used to store information (RF0, RF1) indicating whether each of the arithmetic circuits has been reserved for next use by which of the processor cores, and can be accessed by the processor cores. Thus, when the processor core distributes commands to the arithmetic circuits which are shared resources of the other processor core, it can be determined by referring to the first register whether the arithmetic circuit of the other processor core is already executing a command, so that any conflict between the arithmetic circuits can be easily avoided. When the arithmetic circuit of the other processor core is already executing a command, the arithmetic circuit of the other processor core is reserved for execution of the next command using the second register, and thereby after the execution, the command can be assigned fast to the arithmetic circuit of the other processor core for execution of the commands.

In a concrete embodiment, the processor core refers to the first register, when using the arithmetic circuit of the other processor core, to determine whether the arithmetic circuit of the other processor core is used; supplies a command to the arithmetic circuit of the other processor core when the arithmetic circuit of the other processor core is not used; determines whether or not the arithmetic circuit of the other processor core has been reserved for use when the arithmetic circuit of the other processor core is used, by referring to the second register; reserves the arithmetic circuit of the other processor core when the arithmetic circuit of the other processor core has not been reserved; and supplies a command to the reserved arithmetic circuit when the reserved arithmetic circuit has become available before the arithmetic circuit of its own becomes available. According to the above procedure, when executing a plurality of operation instructions, one processor core can issue a command to the arithmetic circuit of its own and other processor cores efficiently according to reserved or non-reserved states of the arithmetic circuits to cause the arithmetic circuits to execute the operation instructions.

### 2. Detail of Embodiments

The embodiments will be described in more detail.

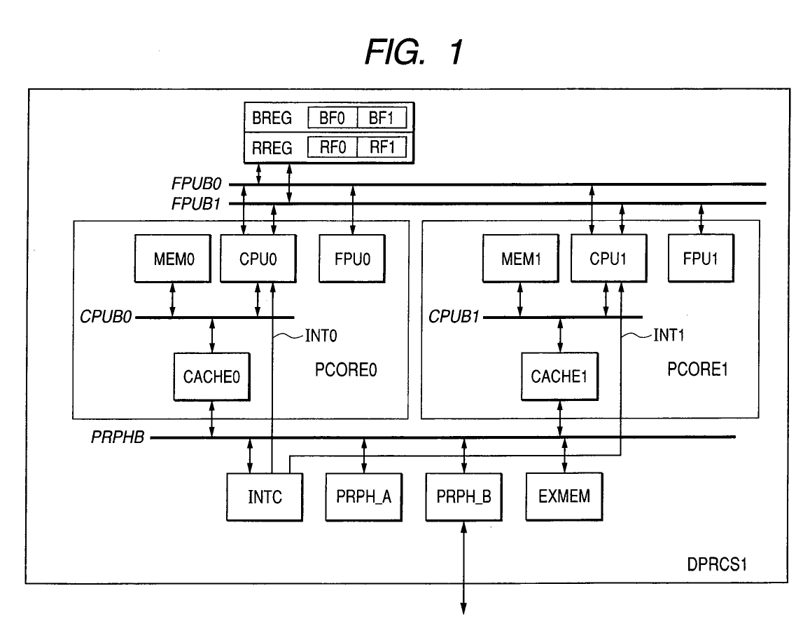

FIG. 1 illustrates a data processing system DPRCS1 according to an example of the present invention. The data processing system DPRCS1 shown in FIG. 1 is formed on one semiconductor substrate such as a single-crystal silicon substrate by a complementary MOS integrated circuit manufacturing technology or the like without a particular limit. The data processing system DPRCS1 has two processor cores PCORE0 and PCORE1. FPU buses FPUB0 and FPUB1 and a peripheral bus PRPHB are disposed outside the processor cores PCORE0 and PCORE1, and an interrupt controller INTC, an external memory EXMEM, and other peripheral circuits PRPH_A and PRPH_B which are typically indicated are coupled with the peripheral bus PRPHB. The peripheral circuit PRPH_A or PRPH_B may be an input/output port, a timer, a serial interface circuit, or the like.

The processor core PCORE0 includes a central processing unit CPU0, a work memory MEM0, a floating-point processing circuit FPU0 which is an example of an arithmetic circuit, and a cache memory CACHE0. The central processing unit CPU0, the work memory MEM0, and the cache memory CACHE0 are commonly coupled with a CPU bus CPUB0. Likewise, the processor core 1 includes a central processing unit CPU1, a work memory MEM1, a floating-point processing circuit FPU1 which is an example of an arithmetic circuit, and a cache memory CACHE1. The central processing unit CPU1, the work memory MEM1, and the cache memory CACHE1 are commonly coupled with a CPU bus CPUB1.

The cache memories CACHE0 and CACHE1 are coupled with the peripheral bus PRPHB, and the external memory EXMEM is used as a primary storage of the cache memories CACHE0 and CACHE1.

The central processing units CPU0 and CPU1 are commonly coupled with the FPU buses FPUB0 and FPUB1, and the floating-point processing circuits FPU0 and FPU1 are commonly coupled with the FPU buses FPUB0 and FPUB1, respectively.

The central processing units CPU0 and CPU1 execute fetched instructions. An instruction set of the data processing system DPRCS1 includes central processing unit instructions (CPU instructions) and floating-point processing circuit instructions (FPU instructions). The central processing unit CPU0 or CPU1 executes a CPU instruction when it has fetched the CPU instruction, and issues an operation command corresponding to the FPU instruction when it has fetched the FPU instruction. Each of the floating-point processing circuits FPU0 and FPU1 has a command register in which an operation command is set by the central processing unit CPU0 or CPU1. Without a particular limit, when it is necessary to obtain an operation operand necessary for execution of a FPU instruction by memory access, the central processing unit CPU0 or CPU1 performs the memory access to set the operand into the data register of FPU0 or FPU1. When the central processing unit CPU0 or CPU1 has fetched a FPU instruction, it is able to set an operation command indicated by the FPU instruction in either of the floating-point processing circuits FPU0 and FPU1. As memory circuits which are referred to for the control, a busy register BREG and a reservation register RREG are commonly coupled with the FPU buses FPUB0 and FPUB1.

The busy register BREG is used to store 1-bit busy flags (first information) BF0 and BF1 indicating which of the floating-point processing circuits FPU0 and FPU1 is executing an operation command, respectively. The busy flag BF0 corresponds to the floating-point processing circuit FPU0, and the busy flag BF1 corresponds to the floating-point processing circuit FPU1. Each of the busy flags indicates, in a set state, that an operation command is being executed, and indicates, in a reset state, that an operation command is not being executed. Without a particular limit, the busy flag BF0 or BF1 is set by the central processing unit CPU0 or CPU1 when the central processing unit CPU0 or CPU1 supplies an operation command to the floating-point processing circuits FPU0 or FPU1, and is reset by the floating-point processing circuit FPU0 or FPU1 when the floating-point processing circuit FPU0 or FPU1 has executed an operation command.

The reservation register RREG is used to store two-bit reservation flags (second information) RF0 and RF1 indicating which of the central processing units CPU0 and CPU1 has reserved the floating-point processing circuits FPU0 and FPU1, respectively, for execution of the next operation command. The reservation flag RF0 corresponds to the floating-point processing circuit FPU0, and the reservation flag RF1 corresponds to the floating-point processing circuit FPU1. In the reservation flags, the value of “00” means that the floating-point processing circuit has not been reserved, the value of “10” means that the floating-point processing circuit has been reserved by the central processing unit CPU0, and the value of “11” means that the floating-point processing circuit has been reserved by the central processing unit CPU1. Reservation setting for the reservation flag RF0 or RF1 is performed by the central processing units CPU0 or CPU1, which performs reservation cancel in parallel with setting an operation command to the reserved floating-point processing circuit FPU0 or FPU1.

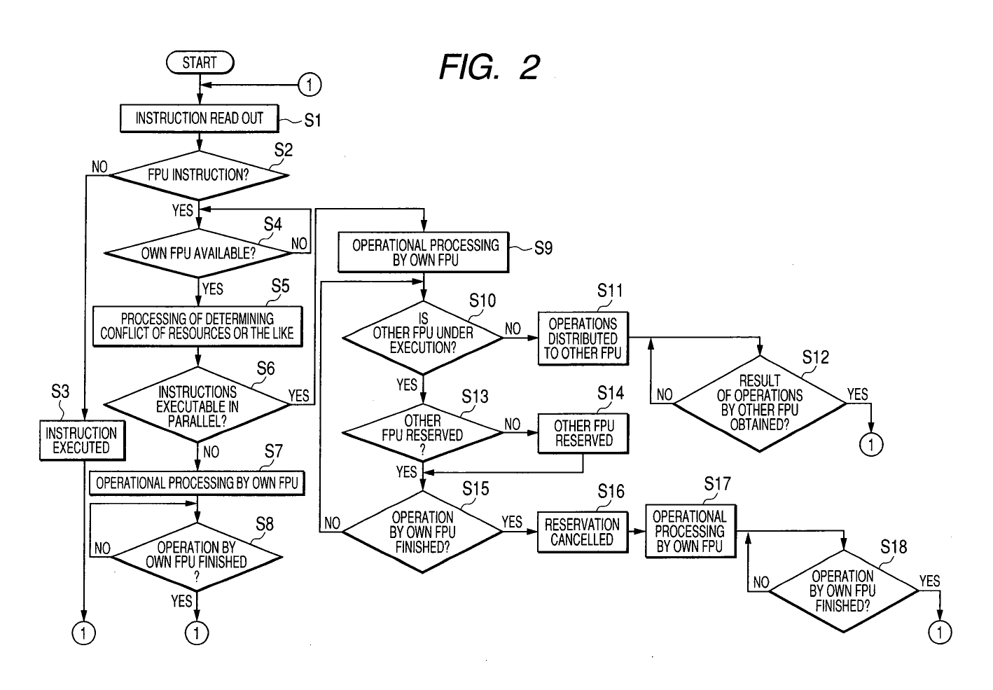

FIG. 2 illustrates an instruction execution sequence performed by a central processing unit. Here, a control sequence performed by one central processing unit CPU0 is described as an example. The central processing unit CPU0 fetches a plurality of instructions as one unit (S1), and determines whether or not the fetched instructions are FPU instructions (S2). When the fetched instructions are CPU instructions, CPU0 executes them (S3). When the fetched instructions are FPU instructions, CPU0 determines whether or not the floating-point processing circuit FPU0 of its own FPU is available (S4). For this determination, CPU0 refers to the busy register BREG and the reservation register RREG. When the floating-point processing circuit FPU0 is executing an operation command, it is recommended that CPU0 reserves the floating-point processing circuit FPU0 for execution of an operation command as required. When the floating-point processing circuit FPU0 is available, CPU0 performs a determination processing for determining whether a problem of a resource conflict such as a register conflict arises when executing the FPU instructions in parallel (S5). As a result of the determination processing, CPU0 determines whether the fetched FPU instructions can be executed in parallel (S6). When the fetched FPU instructions can not be executed in parallel, CPU0 performs operational processing in succession based on the FPU instructions using the floating-point processing circuit FPU0 (S7), and returns to step S1 when the processing is finished (S8). When the fetched FPU instructions can be executed in parallel, CPU0 causes the floating-point processing circuit FPU0 to execute an operation command based on one FPU instruction to be processed in parallel (S9). CPU0 then determines whether the floating-point processing circuit FPU1, which is another FPU caused by CPU0 to execute the other FPU instruction to be processed in parallel, is executing an operation command (S10). For this determination, CPU0 refers to the busy register BREG. When the floating-point processing circuit FPU1 is executing no operation command, CPU0 issues an operation command corresponding to the other FPU instruction to the floating-point processing circuit FPU1 (S11), and then returns to step S1 when CPU0 has obtained the result of the operational processing of the floating-point processing circuit FPU1 (S12). When the floating-point processing circuit FPU1 which is the other FPU is executing an operation command at step 10, CPU0 determines whether CPU0 has reserved the floating-point processing circuit FPU1 for execution of the next operation command (S13). For the determination, it is recommended that CPU0 refers to, for example, the reservation register RREG. When CPU0 has not reserved the floating-point processing circuit FPU1, CPU0 reserves it (S14). After that, CPU0 determines whether the floating-point processing circuit FPU0 of its own being executing an operation has finished the operation (S15). When the floating-point processing circuit FPU0 has not finished the operation, CPU0 repeats the determination loop of steps S10, S13, and S15. When the operation of the other FPU has been finished at step S10, CPU0 causes the floating-point processing circuit FPU1 which is the other FPU to execute an operation command corresponding to the other FPU instruction (S11). On the other hand, when it is detected at step S15 before the operation of the other FPU is finished that the operation of the floating-point processing circuit FPU0 of its own has been finished, CPU0 cancels the reservation for operation of the floating-point processing circuit FPU1 which is the other FPU (S16), and then causes the floating-point processing circuit FPU0 of its own to execute an operation command corresponding to the other FPU instruction (S17). When the floating-point processing circuit FPU0 has finished the operation (S18), CPU0 returns to step S1.

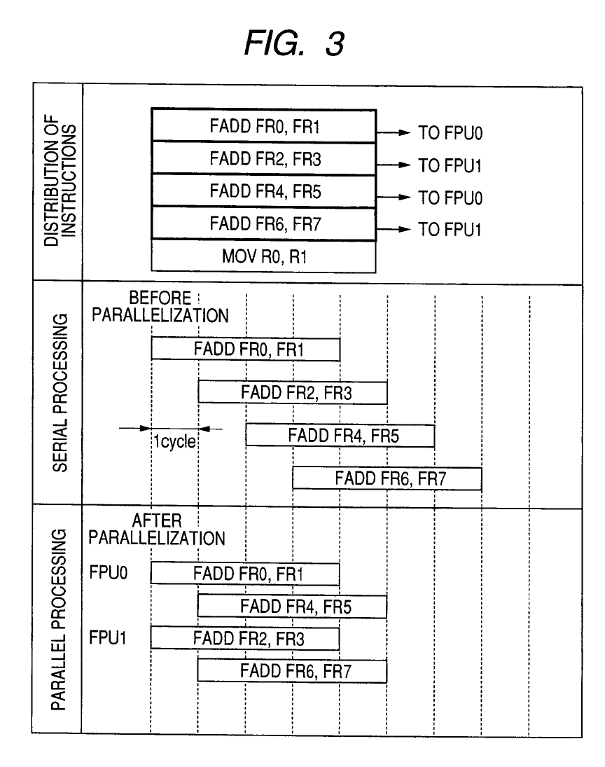

FIG. 3 illustrates the timing of operational processing for a plurality of FPU instructions. In FIG. 3, it is illustrated that four floating-point adding instructions (FADDs) are executed in succession. FR0 to FR7 denote operand registers which are floating point registers. No register conflict has arisen among the four floating-point adding instructions. The FPU instructions are supplied to the floating-point processing circuits FPU and FPU1 as operational commands as they are. The floating-point processing circuits FPU0 and FPU1 are to spend four cycles in executing one operation command, and execute operation commands with cycle-by-cycle pipeline processing. At that time, if parallel execution is not performed, at least seven cycles are required for floating point operation of four instructions, while if parallel execution is performed, at least five cycles are all that is required for floating point operation of four instructions.

In the data processing system DPRCS1, when operation commands are distributed to the floating-point processing circuits FPU0 and FPU1 which are shared resources, it can be determined by referring to the busy register BREG whether the floating-point processing circuit FPU0 or FPU1 is already executing a command, so that any conflict between operational indications for the floating-point processing circuits FPU0 and FPU1 can be easily avoided. When the floating-point processing circuit FPU0 or FPU1 is already executing a command, the floating-point processing circuit is reserved for execution of the next operation command using the reservation register RREG, and thereby after the floating-point processing circuit which is executing an operation has finished the operation, an operation command can be assigned fast to the floating-point processing circuit to cause it to execute the operation command. Thus, when one central processing unit has fetched a plurality of FPU instructions, it is able to issue operation commands to the floating-point processing circuits efficiently according to reserved or non-reserved states of the floating-point processing circuits to cause the floating-point processing circuits to execute operations.

On the other hand, when a plurality of FPU instructions causing any register conflict can be assigned to FPU0 in succession, it is most efficient that FPU0 executes the FPU instructions in succession, so that it is recommended that one central processing unit CPU0 causes FPU0 to execute the first instruction and sets FPU0 to the reservation register RREG to cause FPU0 to execute the subsequent FPU instruction. For example, when the first and second floating-point adding instructions cause a register conflict, the first and second floating-point adding instructions are assigned to FPU0. Furthermore, when the first and fourth floating-point adding instructions cause a register conflict, the first and fourth floating-point adding instructions are assigned to FPU0, and the second and third floating-point adding instructions are assigned to FPU1.

By controlling resource assignment as described above, the processing that information about the registers possessed by the shared resources is saved on a memory and is loaded again onto the shared resources can be cut, and thereby reduction in processing efficiency and increase in power consumption caused by increase in the amount of bus traffic can be suppressed. By such instruction assignment using the reservation register RREG, the central processing units CPU0 and CPU1 capable of using the floating-point processing circuits FPU0 and FPU1 which execute instructions independently and are shared resources can use the shared resources efficiently.

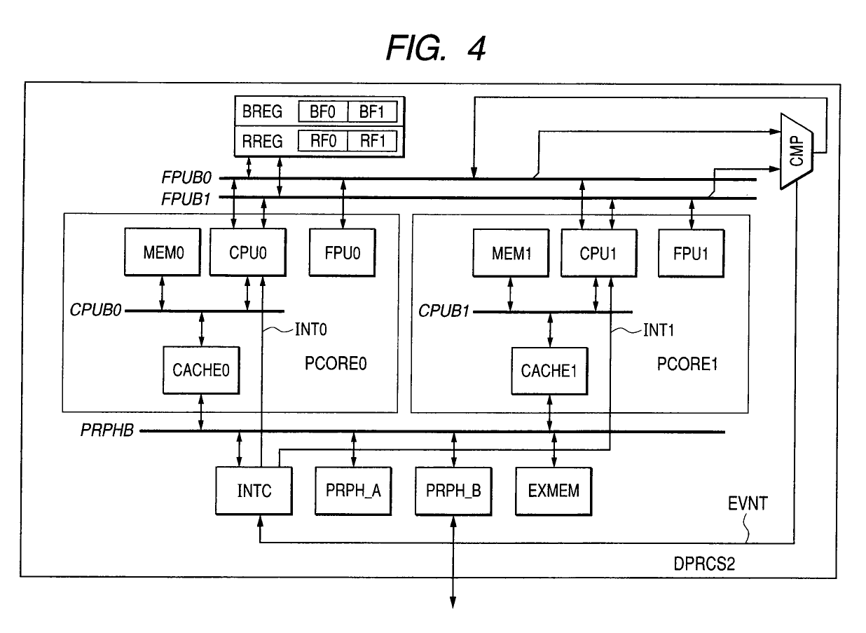

FIG. 4 illustrates another data processing system DPRC2. FIG. 2 is different from FIG. 1 in that a comparison circuit CMP coupled with the FPU buses FPUB0 and FPUB1 is provided. The comparison circuit CMP compares data supplied from the FPU bus FPUB0 with data supplied from the FPU bus FPUB1 and outputs the comparison result to the bus FPUB0. In addition, the comparison circuit CMP outputs the comparison result to the interrupt controller INTC as one interrupt factor EVENT. The interrupt controller INTC outputs interrupt signals INT0 and INT1 to the central processing units CPU0 and CPU1, respectively. Programmable effective interrupt factors are set for each of the interrupt signals INT0 and INT1 by the central processing units CPU0 and CPU1. In other points, FIG. 2 is the same as FIG. 1.

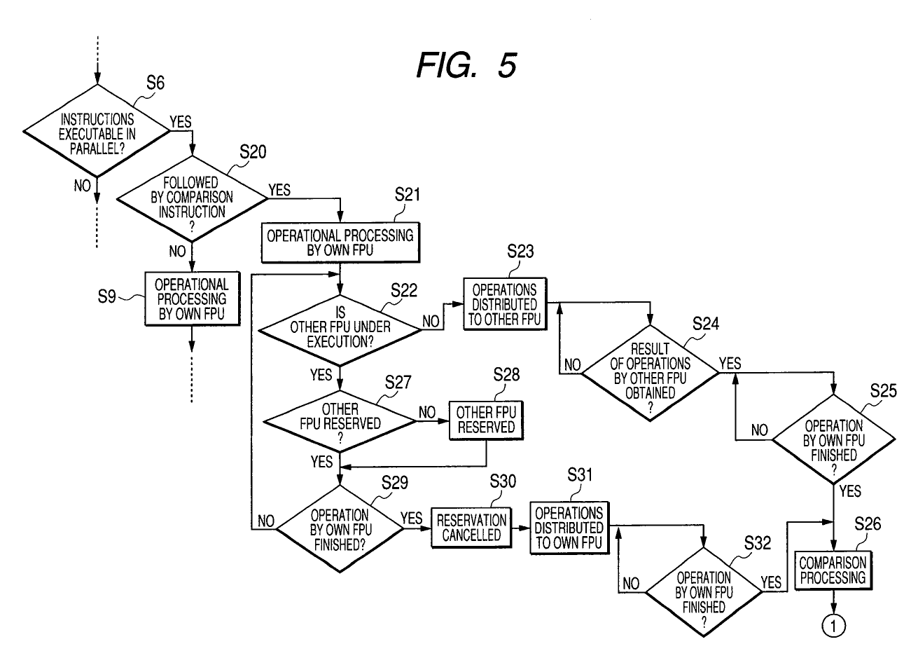

FIG. 5 illustrates an instruction execution sequence for executing a FPU comparison instruction. Here, a control sequence performed by one central processing unit CPU0 is described as an example. The control sequence shown in FIG. 5 is added to the control sequence of FIG. 2, and branches between step S6 and step S9 in the control sequence of FIG. 2. When it is determined at step S6 that FPU instructions can be executed in parallel, CPU0 determines whether the FPU instructions are followed by a FPU comparison instruction (S20), and goes to step S9 when the FPU instructions are not followed by any FPU comparison instruction. When the FPU instructions are followed by a FPU comparison instruction, CPU0 causes the floating-point processing circuit FPU0 first to execute an operational command based on one FPU instruction to be processed in parallel (S21). CPU0 then determines whether the floating-point processing circuit FPU1, which is the other FPU caused by CPU0 to execute the other FPU instruction to be processed in parallel, is executing an operation command (S22). For this determination, CPU0 refers to the busy register BREG. When the floating-point processing circuit FPU1 is not executing an operation command, CPU0 issues an operation command corresponding to the other FPU instruction to the floating-point processing circuit FPU1 (S23). After that, CPU0 waits till it obtains the result of the operational processing of the floating-point processing circuit FPU1 (S24), and then waits till the operational processing of the floating-point processing circuit FPU0 finishes (S25). When the comparison circuit CMP has obtained both of the operation results, CMP compares the operation results, and supplies the result of the comparison to the central processing unit CPU0 (S26). After that, the central processing unit CPU0 fetches the next instruction (S1), and can perform, for example, processing such as conditional branching according to the comparison result. When the floating-point processing circuit FPU1 which is the other FPU is executing an operation command at step 22, CPU0 determines whether it has reserved the floating-point processing circuit FPU1 for execution of the next operation command (S27). For the determination, it is recommended that CPU0 refers to, for example, the reservation register RREG. When CPU0 has not reserved the floating-point processing circuit FPU1, it reserves the floating-point processing circuit FPU1 (S28). After that, CPU0 determines whether the floating-point processing circuit FPU0 of its own being executing an operation has finished the operation (S29). When the floating-point processing circuit FPU0 has not finished the operation, CPU0 repeats the determination loop of steps S22, S27, and S29. When the operation of the floating-point processing circuit FPU1 has been finished at step S22, CPU0 causes the floating-point processing circuit FPU1 to execute an operation command corresponding to the other FPU instruction as described above. On the other hand, when it is detected at step S29 before the operation of the floating-point processing circuit FPU1 is finished that the operation of the floating-point processing circuit FPU0 has been finished, CPU0 cancels the reservation for operation of the floating-point processing circuit FPU1 (S30), and then causes the floating-point processing circuit FPU0 to execute an operation command corresponding to the other FPU instruction (S31). When the operation of the floating-point processing circuit FPU0 has been finished (S32), CPU0 goes to the step of comparison processing. In this case, two floating point operations to be compared are performed in succession by one floating-point processing circuit FPU0.

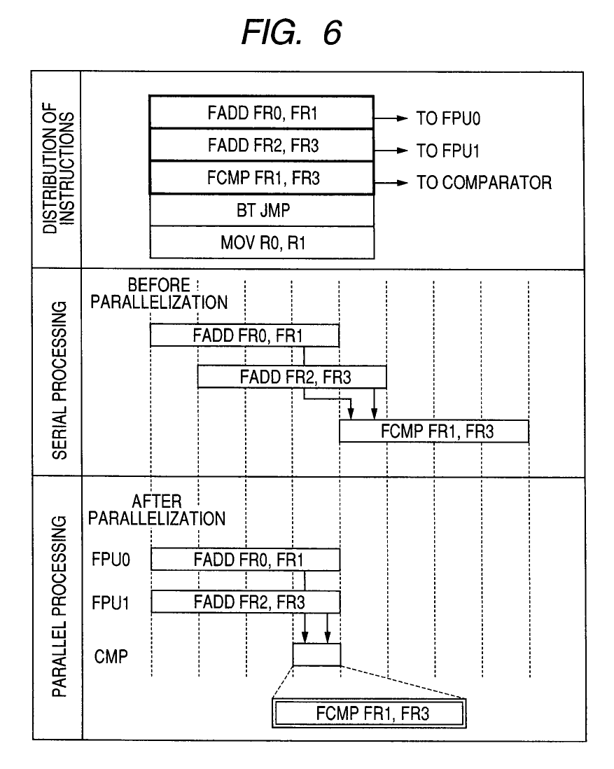

FIG. 6 illustrates the timing of operational processing performed when addition results obtained according to floating-point adding instructions are compared according to a comparison instruction. In FIG. 6, it is illustrated that two floating-point adding instructions (FADDs) are executed and the results are compared according to a floating-point comparison instruction (FCMP). FR0 to FR7 denote operand registers which are floating point registers. No register conflict has arisen between the two floating-point adding instructions. The FPU instructions are supplied to the floating-point processing circuits FPU0 and FPU1 as operation commands as they are. The floating-point processing circuits FPU and FPU1 are to spend four cycles in executing one operation command, and execute operation commands with cycle-by-cycle pipeline processing. At that time, adding operations are performed in parallel as shown in the parallel processing column by passing the steps of S21 to S26 shown in the flow chart of FIG. 5, and a comparison result can be obtained by comparing the operation results obtained in parallel by the comparison circuit CMP. The comparison result can be obtained in at least four cycles. Since the comparison circuit CMP as a dedicated hardware is used for the comparison processing, it is assumed that the comparison operation is finished in one cycle. In contrast to this, eight cycles are required for serial processing of executing instructions in succession. The comparison circuit CMP as a dedicated hardware is used for comparing the results of the adding operations also when passing the steps of S29 to S26 of FIG. 5, thereby contributing to increase of the processing efficiency correspondingly.

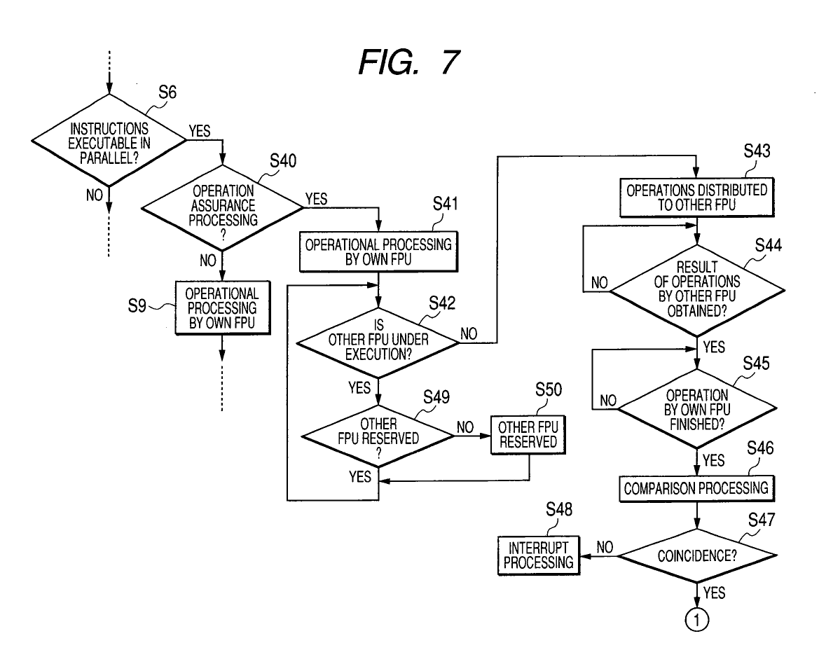

FIG. 7 illustrates an instruction execution sequence of operation assurance processing for enhancing the assurance of operation results obtained according to FPU instructions. Here, a control sequence performed by one central processing unit CPU0 is described as an example. The control sequence shown in FIG. 7 is added to the control sequence of FIG. 2, and branches between step S6 and step S9 in the control sequence of FIG. 2. When it is determined at step S6 that FPU instructions can be executed in parallel, CPU0 determines whether the FPU instructions are objects of operation assurance processing (S40), and goes to step S9 when the FPU instructions are not objects of operation assurance processing. It is recommended that CPU0 determines whether the FPU instructions are objects of operation assurance processing based on the operation codes of the FPU instructions or the operation modes of the data processing system. When the FPU instructions are objects of the operation assurance processing, CPU0, at first, causes one floating-point processing circuit FPU0 to execute an operation command based on one FPU instruction which is object of operation assurance processing (S41). In parallel with this, CPU0 determines whether the other the floating-point processing circuit FPU1 is executing an operation command (S42). For this determination, CPU0 refers to the busy register BREG. When the floating-point processing circuit FPU1 is executing an operation command, CPU0 determines whether it has reserved the floating-point processing circuit FPU1 for execution of the next operation command (S49). For the determination, it is recommended that CPU0 refers to, for example, the reservation register RREG. When CPU0 has not reserved the floating-point processing circuit FPU1 (S50), CPU0 returns to step S42. When CPU0 determines at step S42 that the floating-point processing circuit FPU1 is not executing any operation command, CPU0 issues an operation command corresponding to a FPU instruction which is an object of operation assurance processing to the floating-point processing circuit FPU1 also. After that, CPU0 waits till it obtains the result of the operation processing of the floating-point processing circuit FPU1 (S44), and then waits till the operation processing of the floating-point processing circuit FPU0 is finished (S45). When CPU0 has obtained both of the operation results, CPU0 compares the operation results by the comparison circuit CMP, and supplies the comparison result to the interrupt controller INTC as an event signal EVNT. The central processing unit CPU0 which receives an interrupt signal INTO when the interrupt controller INTC detects the occurrence of an event indicating that the comparison result is anticoincidence (S47) performs predetermined interrupt processing, and performs a reoperation for anticoincidence of the operation results or any other exceptional processing. When the comparison result is coincidence, interruption is not required, and CPU0 returns to the start to fetch the next instruction (S1).

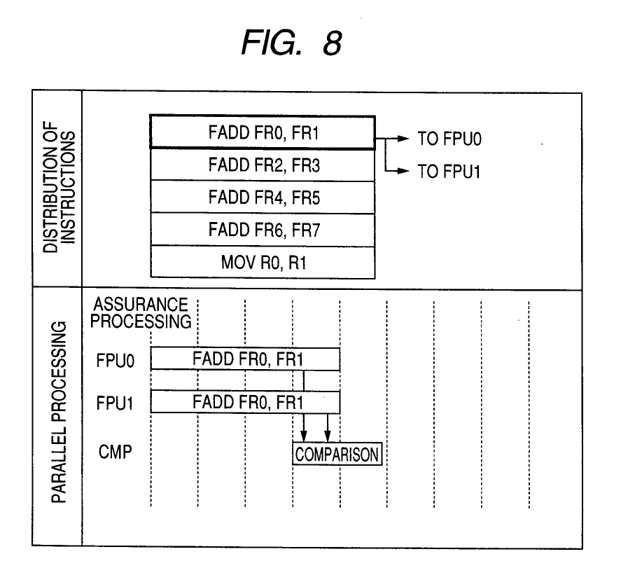

FIG. 8 illustrates the timing of operational processing for FPU instructions which are objects of operation assurance processing. Here, it is illustrated that an adding instruction of “FADD FRO, FR1” is executed as an FPU instruction which is an object of operation assurance processing. The two floating-point processing circuits FPU0 and FPU1 are operated in parallel and the comparison circuit CMP which is a dedicated hardware is used, so that the FPU instructions which are objects of operation assurance processing can be executed in at least four cycles.

In the data processing system DPRCS2 in FIG. 4, the results of operation of the floating-point processing circuits FPU0 and FPU1 can be input to the comparison circuit CMP from the operation buses FPUB0 and FPUB1 through the central processing units CPU0 and CPU1, and can be compared by the comparison circuit CMP. Thus, in such a case of executing two operation instructions, comparing the results of the operations, and then executing instructions using the result of the comparison, the number of steps of executing the instructions can be reduced. Furthermore, it becomes possible that an operation command according to one operation instruction is supplied to the two floating-point processing circuits FPU0 and FPU1 to cause the floating-point processing circuits FPU0 and FPU1 to operate individually, and the results of the operations are compared with the comparison circuit CMP, so that it is also becomes possible to assure higher reliability than usual for the results of operation of the floating-point processing circuits FPU0 and FPU1. The interrupt controller INTC receives the result of comparison by the comparison circuit CMP as one interrupt factor EVENT, so that when the comparison is anticoincidence, reexecution of an operation instruction, failure verification processing for the floating-point processing circuits FPU0 and FPU1, failure reporting processing for the outside, and the like can be performed according to the interrupt handling program of the interrupt controller INTC.

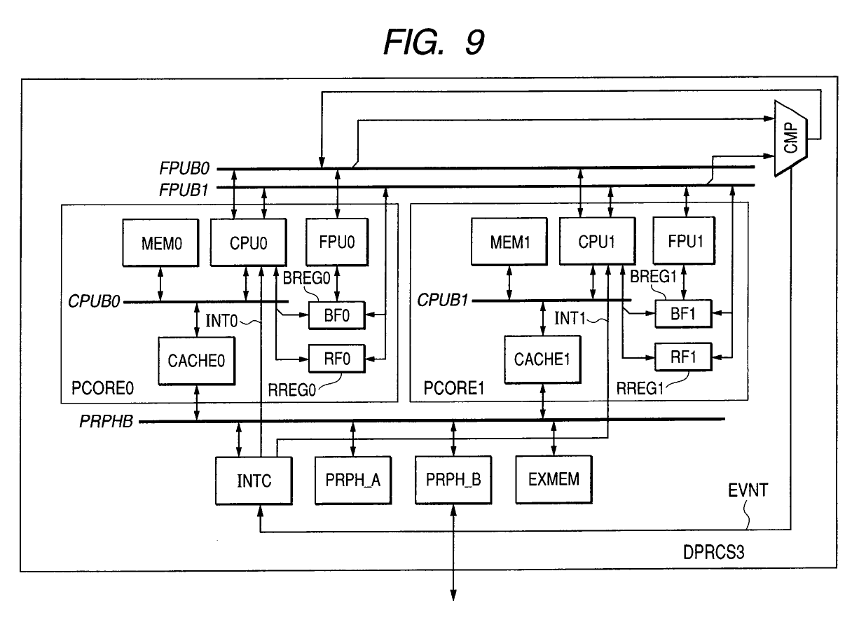

FIG. 9 illustrates still another data processing system DPRCS3. FIG. 9 is different from FIG. 4 in that a busy register and a reservation register are provided in each of the processor cores PCORE0 and PCORE1. The processor core PCORE0 has a busy register BREG0 and a reservation register RREG0. The busy register BREG0 has the above busy flag BF0, and the reservation register RREG0 has the above reservation flag RF0. The significances of the flags BF0 and RF0 are equivalent to those of the data processing system DPRCS1 shown in FIG. 1. The busy flag BF0 and the reservation flag RF0 are directly coupled to the central processing unit CPU0 and are coupled to the FPU bus FPUB1, and are referred and operated by CPU0, CPU1, FPU0, and FPU1 as described above. The processor core PCORE1 has a busy register BREG1 and a reservation register RREG1. The busy register BREG1 has the above busy flag BF1, and the reservation register RREG1 has the above reservation flag RF1. The significances of both of the flags BF1 and RF1 are equivalent to those of the data processing system DPRCS1 shown in FIG. 1. The busy flag BF1 and the reservation flag RF1 are directly coupled to the central processing unit CPU1 and are coupled to the FPU bus FPUB0, and are referred and operated by CPU0, CPU1, FPU0, and FPU1 as described above. The registers configured like this are operated as those of the data processing system DPRCS1 in FIG. 1 and the data processing system DPRCS2 in FIG. 4, while the busy register and the reservation register in the same processor core can be referred fast by the central processing unit of its own, because it is not required to access the registers through FPUB0 and FPUB1 as common buses.

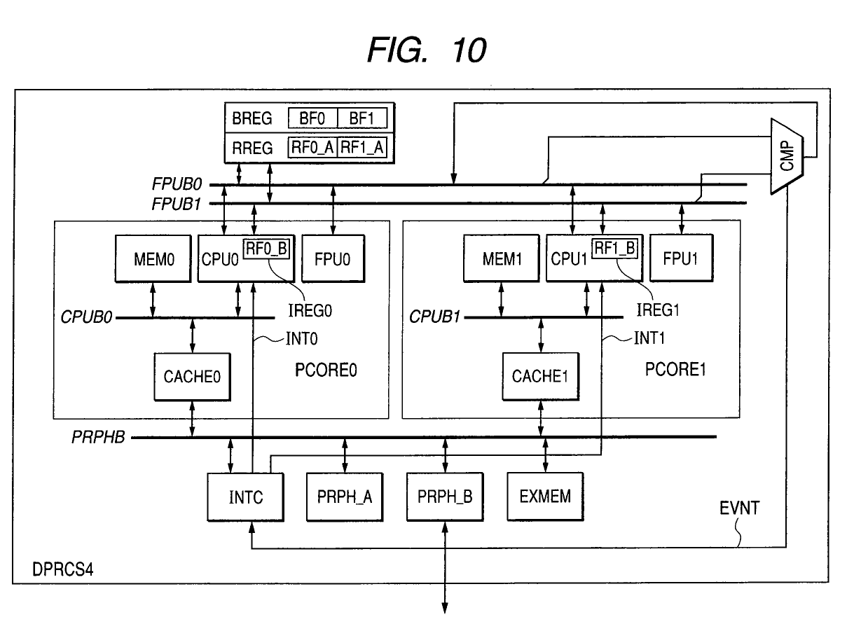

FIG. 10 shows a data processing system DPRCS4 in which another example regarding reservation bits is applied. The data processing system DPRCS4 is different from the data processing system DPRCS2 in FIG. 4 in that the significances of the reservation flags are divided. One-bit reservation flags RF0_A and RF1_A are configured for the reservation register RREG. Each of them indicates, in a set state, that FPU0 or FPU1 has been reserved, and indicates, in a reset state, that FPU or FPU1 has not been reserved. In short, When the reservation flag RF0_A or RF1_A is referred, it is understood only that the floating-point processing circuit FPU0 or FPU1 has been reserved or not. At that time, the central processing unit CPU0 stores information indicating that CPU0 has reserved which of the floating-point processing circuits FPU0 and FPU1 for operation as internal information RF0_B into an internal register IREG0 such as a temporary register in addition to the reservation register RREG. Likewise, the central processing unit CPU1 stores information indicating that CPU1 has reserved which of the floating-point processing circuits FPU0 and FPU1 for operation as internal information RF1_B into an internal register IREG1 such as a temporary register separately from the reservation register RREG. Each of the internal information RF0_B and RF1_B is of, for example, 2 bits. The value of “00” means that any of FPU0 and FPU1 has not been reserved, the value of “01” means that FPU0 has been reserved, and the value of “10” means that FPU1 has been reserved. In this configuration, when CPU0 or CPU1 verifies the reservation made by itself, it does not need to refer to the external reservation register RREG. The reservation register RREG is used to verify whether the other central processing unit has reserved FPU0 or FPU1 for operation. The reservation register RREG can be neglected provided that each of the central processing units CPU0 and CPU1 can refer the internal information RF0_B and RF1_B, which is not particularly shown in the figure.

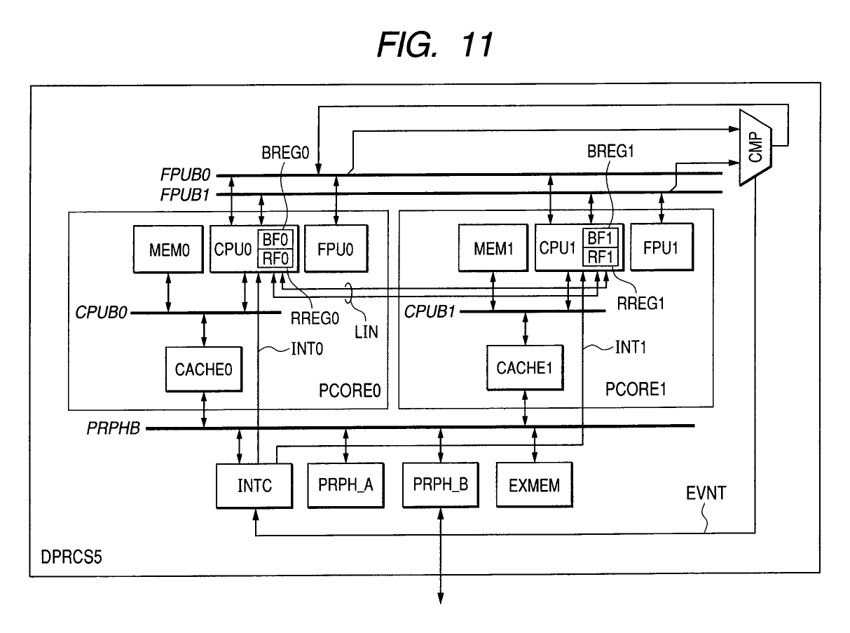

FIG. 11 illustrates still another data processing system DPRCS5. FIG. 11 is different from FIG. 4 in that a busy register and a reservation register are provided in each of the central processing units CPU0 and CPU1, and can be operated mutually by the central processing units through dedicated signal wires. The central processing unit CPU0 has a busy register BREG0 and a reservation register RREG0.

The busy register BREG0 has the above busy flag BF0, and the reservation register RREG0 has the above reservation flag RF0. The central processing unit CPU1 has a busy register BREG1 and a reservation register RREG1. The busy register BREG1 has the above busy flag BF1, and the reservation register RREG1 has the above reservation flag RF1. The significances of the flags BF0, RF0, BF1, and RF1 are basically equivalent to those of the data processing system DPRCS1 shown in FIG. 1. However, the central processing units CPU0 and CPU1 are designed to be able to mutually refer and operate the busy register and reservation register of each other through one-to-one dedicated signal lines. Although it is not absolutely required to access the registers through FPUB0 and FPUB1 as common buses, the one-to-one dedicated signal wires LIN are complicated. RF0_B in FIG. 10 may be employed instead of RF0, and RF1_B in FIG. 10 may be employed instead of RF1, which is not particularly shown in the figure.

Up to this point, the present invention made by the inventors has been concretely described based on the embodiments. However, it is needless to say that the present invention is not limited to them, and various modifications can be made thereto without departing from the gist of it.

For example, the numbers of processor cores, central processing units, and floating-point processing circuits may be three or more. The arithmetic circuits are not limited to floating-point processing circuits, and may be appropriate circuits performing operational processing under control of central processing units, such as coding and decoding circuits, image processing circuits, or speech processing circuits. The memory which is used as a primary storage of the cache memories may be an external memory coupled with the outside of the data processing system rendered a semiconductor integrated circuit. Each of the processor cores may not have any cache memory, and may have an address conversion buffer used for virtual storage. The present invention can be widely applied to data processing systems in which a plurality of arithmetic circuits can be used as operation resources for one central processing unit. The data processing system of the present invention is not limited to a single-chip one, and may be a multi-chip one.

What is claimed is:

1. A data processing system comprising:
a plurality of central processing units;
a plurality of arithmetic circuits capable of executing a command supplied from the central processing units; and
a memory circuit,
wherein the central processing unit is able to supply a command to one arithmetic circuit based on one fetched instruction and supply a command to other arithmetic circuit based on other fetched instruction, and
wherein the memory circuit is used to store first information indicating which arithmetic circuit is executing the command and second information indicating which central processing unit has reserved the arithmetic circuit for execution of the next command.

2. The data processing system according to claim 1,
wherein the central processing unit causes one arithmetic circuit assigned thereto to execute a first command; determines, when using other arithmetic circuit assigned to other central processing unit, whether or not the other arithmetic circuit is executing a command by referring to the first information; supplies a second command to the other arithmetic circuit when the other arithmetic circuit is not executing a command; determines, when the other arithmetic circuit is executing a command, whether or not the other arithmetic circuit has been reserved for command execution by referring to the second information; reserves the other arithmetic circuit when the other arithmetic circuit has not been reserved; supplies the second command to the other arithmetic circuit when the command execution of the other arithmetic circuit has finished before the one arithmetic circuit finishes execution of the first command; and supplies the second command to the one arithmetic circuit when the other arithmetic circuit is still executing the command when the one arithmetic circuit has finished execution of the first command.

3. The data processing system according to claim 1,
wherein the arithmetic circuit is a floating-point processing circuit or a digital signal processing arithmetic circuit.

4. The data processing system according to claim 3,
wherein the arithmetic circuit operates the first information, when finished operations according to a supplied operation command, so as to indicate that the arithmetic circuit is not executing a command.

5. The data processing system according to claim 1, further comprising:
a plurality of arithmetic buses which are individually coupled with the respective arithmetic circuits, and are commonly coupled with the central processing units.

6. The data processing system according to claim 5,
wherein the memory circuit is commonly coupled with the arithmetic buses.

7. The data processing system according to claim 5, further comprising:
a comparison circuit coupled with the arithmetic buses,
wherein one input of the comparison circuit is coupled with one of the arithmetic buses, and the other input of the comparison circuit is coupled with the other of the arithmetic buses.

8. The data processing system according to claim 7, further comprising:
an interrupt controller receiving a comparison result by the comparison circuit as an interrupt factor.

9. A data processing system comprising:
a plurality of central processing units;
a plurality of arithmetic circuits capable of executing a command supplied from the central processing units; and
a memory circuit,
wherein the central processing unit is able to supply a command to one arithmetic circuit based on one fetched instruction and supply a command to other arithmetic circuit based on other fetched instruction, and
wherein the memory circuit is used to store first information indicating which arithmetic circuit is executing the command and second information indicating whether the arithmetic circuit has been reserved for execution of the next command.

10. The data processing system according to claim 9,
wherein the central processing unit causes one arithmetic circuit assigned thereto to execute a first command; determines, when using other arithmetic circuit assigned to other central processing unit, whether or not the other arithmetic circuit is executing a command by referring to the first information; supplies a second operation command to the other arithmetic circuit when the other arithmetic circuit is not under command execution; determines, when the other arithmetic circuit is executing command, whether or not the other arithmetic circuit has been reserved for command execution by referring to the second information; reserves the other arithmetic circuit when the other arithmetic circuit has not been reserved by other central processing unit or by the central processing unit itself; supplies the second command to the other arithmetic circuit when the command execution of the other arithmetic circuit has finished before the one arithmetic circuit finishes execution of the first command; and supplies the second command to the one arithmetic circuit when the other arithmetic circuit is still under command execution when the one arithmetic circuit has finished execution of the first command.

11. The data processing system according to claim 10,
wherein the central processing unit has an internal memory circuit for storing information indicating to which arithmetic circuit operation has been reserved.

12. A data processing system comprising:
a plurality of processor cores;
a first register; and
a second register,
wherein the processor core includes an arithmetic circuit which receives an operation command from its own and other processor cores to operate,
wherein the first register is used to store information indicating whether each of the arithmetic circuits is used, and is able to be accessed by the processor cores, and
wherein the second register is used to store information indicating whether each of the arithmetic circuits has been reserved for next use by which processor core, and is able to be accessed by the processor cores.

13. The data processing system according to claim 12,
wherein an processor core refers to the first register, when using an arithmetic circuit of other processor core, to determine whether or not the arithmetic circuit is used; supplies an operation command to the arithmetic circuit when the arithmetic circuit is not used; determines, when the arithmetic circuit is used, whether or not the arithmetic circuit has been reserved for use by referring to the second register; reserves the arithmetic circuit when the arithmetic circuit has not been reserved; and supplies an operation command to the reserved arithmetic circuit when the reserved arithmetic circuit has become available before the arithmetic circuit of the own processor core becomes available.

14. The data processing system according to claim 13, wherein an arithmetic circuit operates the first register, when the arithmetic circuit has finished operations according to a supplied operation command, so as to indicate that the arithmetic circuit is not used.

15. The data processing system according to claim 12,
wherein the processor core processes, when there is no register resource conflict among a plurality of prefetched instructions, part of the instructions using the arithmetic circuit; when using, for processing the other instructions, an arithmetic circuit of other processor core, determines whether or not the arithmetic circuit is used by referring to the first register; supplies an operation command to the arithmetic circuit when the arithmetic circuit is not used; determines, when the arithmetic circuit is used, whether or not the arithmetic circuit has been reserved for use by referring to the second register; reserves the arithmetic circuit when the arithmetic circuit has not been reserved; and supplies an operation command to the arithmetic circuit when the reserved arithmetic circuit has become available before the arithmetic circuit of the own processor core becomes available.

16. The data processing system according to claim 9,
wherein each of the processor cores has a central processing unit capable of issuing an operation command to the arithmetic circuit,
wherein each of the arithmetic circuits is individually coupled with an arithmetic bus, and
wherein each of the central processing units is commonly coupled with the arithmetic bus.

17. The data processing system according to claim 16,
wherein the first register and the second register are commonly used by the respective processor cores and are commonly coupled with the arithmetic bus.

18. The data processing system according to claim 16,
wherein the arithmetic bus is separated into a first common bus which is coupled with part of the arithmetic circuits, and a second common bus which is coupled with the remained arithmetic circuits, and
wherein the data processing system further comprises:
a comparison circuit comparing an operation result from one operation resource input through the first common bus with an operation result from the other operation resource input through the second common bus; and
an interrupt controller which receives the comparison result by the comparing circuit as an interrupt factor and outputs interrupt signals to the central processing units.
